(19) United States
(12) Patent Application Publication
(10) Pub. No.: US 2006/0088373 A1
(43) Pub. Date: Apr. 27, 2006

(54) Connector with multiple diameter canister

(76) Inventor: Denzil Haight, North Beamsville (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/973,118

(22) Filed: Oct. 26, 2004

(51) Int. Cl. F16C 11/00

(52) U.S. Cl. 403/122

(57) ABSTRACT

An apparatus (10) connects a first vehicle part (12) to a second vehicle part (14) and enables relative movement between the parts. The apparatus (10) includes a canister (30) having a cylindrical side wall (32) that defines a chamber (34) of the canister. The side wall (32) includes a central portion (90) having an outside diameter greater than upper and lower portions (80 and 90) of the side wall. The apparatus (10) also includes a member (40) supported by the canister (30) for movement relative to the canister. The member (40) is fixedly connected to the second vehicle part (12). At least a portion of the member (40) is positioned in the chamber (34). The central portion (90) and the lower portion (84) of the canister (30) are inserted into an opening (16) in the first vehicle part (12). A portion (122) of the first vehicle (12) part is rolled over adjacent the intersection of the upper portion (80) and the central portion (90) to help fixedly connect the canister (30) to the first vehicle part (12).

### TECHNICAL FIELD

The present invention relates to an apparatus for connecting a first vehicle part to a second vehicle part for relative movement. In particular, the present invention relates to a ball joint or a bushing that includes a multiple diameter canister.

### BACKGROUND OF THE INVENTION

It is known to provide a connection between first and second vehicle parts for relative movement. One such type of connection is a ball joint. A typical ball joint includes a canister and a ball stud. The ball stud has a ball portion received in the canister and a shank portion projecting from the canister. The canister is fixedly connected to a first vehicle part and the shank portion is fixedly connected to a second vehicle part. The ball stud is supported for pivotal and/or rotational movement relative to the canister. The ball joint thus enables the first vehicle part to move relative to the second vehicle part.

Another type of apparatus that connects a first vehicle part to a second vehicle part for relative movement is a bushing. A typical bushing includes a canister, commonly referred to as an outer ring, and an inner ring supported in the outer ring by an intermediate ring. The outer ring is fixedly connected to the first vehicle part and the inner ring is slidable relative to the second vehicle part. The bushing thus enables the first vehicle part to move relative to the second vehicle part.

### SUMMARY OF THE INVENTION

The present invention relates to an apparatus for connecting a first vehicle part to a second vehicle part and enabling relative movement between the first and second vehicle parts. The apparatus includes a canister fixedly connected to the first vehicle part. The canister includes a generally cylindrical side wall that defines a generally cylindrical chamber of the canister. The side wall has an upper portion, an opposite lower portion, and a central portion positioned between the upper and lower portions. The central portion has an outside diameter greater than the outside diameters of the upper and lower portions.

The apparatus further includes a member supported by the canister. The member is fixedly connected to the second vehicle part and enables movement of the second vehicle part relative to the canister.

The central portion and the lower portion of the canister are inserted into an opening in the first vehicle part. A portion of the first vehicle part is rolled over adjacent the intersection of the upper portion and the central portion to help connect the canister to the first vehicle part.

The present invention also relates to a method for supporting a first vehicle part for movement relative to a second vehicle part. The method includes the step of providing a canister for connection to the first vehicle part. The canister includes a generally cylindrical side wall that defines a generally cylindrical chamber of the canister. The canister has an upper portion, an opposite lower portion, and a central portion positioned between the upper and lower portions. The central portion has an outside diameter greater than the outside diameters of the upper and lower portions. The method also includes the step of providing a member supported by the canister. The member is fixedly connected to the second vehicle part and enables movement of the second vehicle part relative to the canister. The method further includes the steps of inserting the central portion and the lower portion into the first vehicle part and rolling over a portion of the first vehicle part to help connect the canister to the first vehicle part. The portion of the first vehicle part being adjacent the intersection of the upper portion and the central portion.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic view, partially in section, of an apparatus for connecting a first vehicle part to a second vehicle part and enabling relative movement between the first and second vehicle parts, according to a first embodiment of the present invention;

FIG. 2 is a schematic view, partially in section, illustrating the assembly of the apparatus of FIG. 1;

FIG. 3 is a schematic view, partially in section, of an apparatus for connecting a first vehicle part to a second vehicle part and enabling relative movement between the first and second vehicle parts, according to a second embodiment of the present invention; and

FIG. 4 is a schematic view, partially in section, illustrating the assembly of the apparatus of FIG. 1.

### DETAILED DESCRIPTION OF THE INVENTION

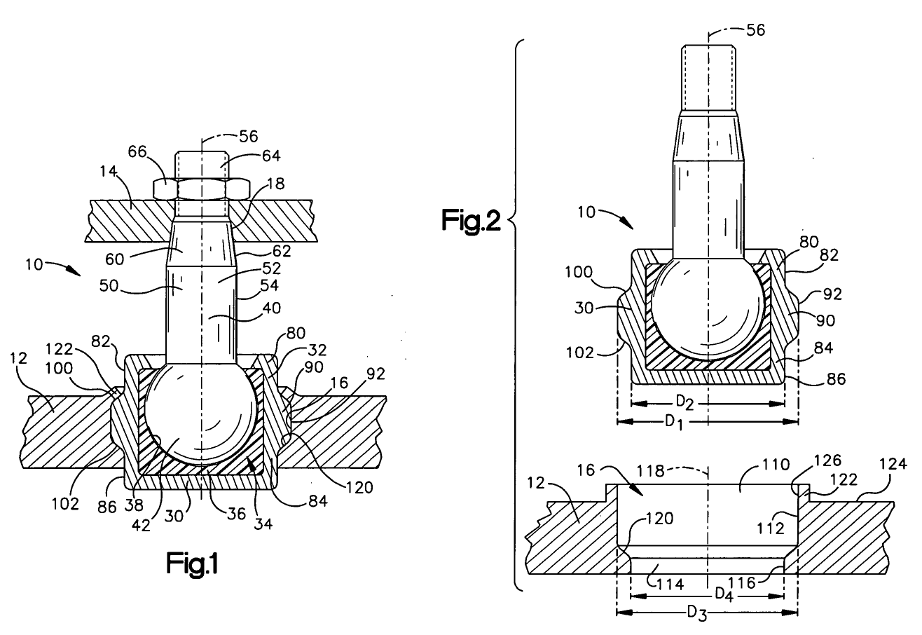

The present invention relates to an apparatus for connecting a first vehicle part to a second vehicle part and enabling relative movement between the first and second vehicle parts. According to a first embodiment of the present invention, the apparatus comprises a ball joint. The first embodiment of the present invention is applicable to various ball joint constructions. As representative of the first embodiment of the invention, FIG. 1 illustrates a ball joint 10. The ball joint 10 extends between a first vehicle part shown partially at 12 and a second vehicle part shown partially at 14.

The first vehicle part 12 may be a steering knuckle or steering yoke, for example. The first vehicle part 12 has a generally cylindrical opening 16 for receiving the ball joint 10. The second vehicle part 14 may be a control arm or steering yoke or steering knuckle, for example. The second vehicle part 14 has a frustoconical surface that defines a tapered bore or opening indicated at 18.

The ball joint 10 is generally of a conventional construction and includes a canister 30 and a ball stud 40. The canister 30 is mounted in the opening 16 in the first vehicle part 12 to fixedly connect the canister to the first vehicle part.

The canister 30 includes a side wall 32 that defines a chamber 34 of the canister. A bearing 36 is located in the chamber 34. A semispherical ball end portion 42 of the ball stud 40 is received in the chamber 34 by the bearing 36. The ball end portion 42 is positioned in mating and abutting engagement with a semispherical bearing surface 38 of the bearing 36. The ball end portion 42 of the ball stud 40 is pivotable and rotatable in the bearing 36 and movable over the bearing surface 38 to provide for relative movement between the ball stud 40 and the canister 30.

The ball stud 40 has a shank portion 50 that projects from the ball end portion. The shank portion 50 has a cylindrical first section 52 centered on a longitudinal central axis 56 of the ball stud 40. The first section has a cylindrical outer surface 54. The shank portion 50 also has a second section 60 that has a tapered outer surface 62 centered on the axis 56. The shank portion 50 also has a threaded end section 64.

The ball stud 40 is fixedly connected to the second vehicle portion 14. When the ball stud 40 is connected to the second vehicle portion 14, the tapered portion 60 of the shank 50 is fitted in the tapered opening 18 in the second vehicle portion in a tight, force-fitting connection. A fastener 66, such as a nut, is screwed on the threaded end section 64 of the ball stud 40 to secure the connection between the ball stud and the second vehicle portion 14.

The ball joint 10 may also include a seal (not shown) which extends between the canister 30 and the first section 52 of the ball stud 40. The seal may help seal in lubricant that is contained in the ball joint 10 and also may help prevent the ingress of any material from outside the ball joint 10, such as dirt or oil.

The canister 30 is fixedly connected to the first vehicle part 12. According to the present invention, the canister 30 has a multiple diameter construction for helping to connect the canister to the first vehicle part 12. Referring to FIGS. 1 and 2, the side wall 32 of the canister 30 includes an upper portion 80 with a cylindrical outer surface 82, a lower portion 84 with a cylindrical outer surface 86, and a central portion 90 with a cylindrical outer surface 92. The central portion 90 is disposed between the upper and lower portions 80 and 84. The upper portion 80, lower portion 84, and central portion 89 are centered on the axis 56.

Referring to FIG. 2, the central portion 90 has an outside diameter, indicated generally at D₁, that is larger than the outside diameter of the upper and lower portions 80 and 84. In the first embodiment of the invention, the upper and lower portions 80 and 84 have equal diameters, indicated generally at D₂. The central portion 90 forms upper and lower annular ridges 100 and 102, respectively. The upper annular ridge 100 extends from the outer surface 92 of the central portion 90 to the outer surface 82 of the upper portion 80. The lower annular ridge 102 extends from the outer surface 92 of the central portion 90 to the outer surface 86 of the lower portion 84.

The opening 16 in the first vehicle part 12 includes an upper portion 110 with a cylindrical inner surface 112 and a lower portion 114 with a cylindrical inner surface 116. The upper portion 110 and lower portion 114 are centered on an axis 118 of the opening 16.

The upper portion 110 has an inside diameter indicated generally at D₃. The lower portion 114 has an inside diameter indicated generally at D₄. The inside diameter D₃ is greater than the inside diameter D₄. The lower portion 114 forms an annular ridge 120 that extends from the inner surface 116 of the lower portion 114 to the inner surface 112 of the upper portion 110.

The first vehicle part 12 also includes an annular rim 122 that projects from an upper surface 124 of the first vehicle part. The rim 122 includes an inner surface 126 that, prior to connection of the first vehicle part 12 with the ball joint 10, extends generally coextensive with and parallel to the inner surface 112 of the upper portion 110 of the opening 16.

As illustrated in FIG. 2, prior to connecting the canister 30 to the first vehicle part 12, the axis 56 of the ball joint 10 is aligned with the axis 118 of the opening 16. The opening 16 is sized so as to form an interference fit with the central portion 90 of the canister 30, the lower portion 84 of the canister, or both the central and lower portions of the canister. The interference could be between the lower portion 114 of the opening 16 and the lower portion 84 of the canister 30, i.e., the diameter D₄ of the lower portion 116 is less than the diameter D₂ of the lower portion 84. The interference could also be between the upper portion 110 of the opening 16 and the central portion 90 of the canister 30, i.e., the diameter D₃ of the upper portion 110 is less than the diameter D₁ of the central portion 90.

The canister 30 is press fitted or otherwise inserted into the opening 16 to form the interference fit between the opening and the canister. Once the canister 30 is fully inserted in the opening 16 such that the lower ridge 102 of the canister is seated against the ridge 120 of the first vehicle part 12, the rim 122 is rolled over against the upper ridge 100 of the canister to help retain the canister seated in the opening. Preferably, the rim 122 is rolled over by a roll form or swage.

The canister 30 is thus connected to the first vehicle part 12, as illustrated in FIG. 1. The interference fit between the canister 30 and the opening 16, in combination with the engagement of the lower ridge 102 and the ridge 120 and the engagement of the upper ridge 100 and the rim 122, helps provide a strong and reliable connection between the ball joint 10 and the first vehicle part 12. The second vehicle part 14, being connected to the shank portion 50, is thus connected to the first vehicle part 12 by the ball joint 10. The ball joint 10 thus enables relative movement between the first vehicle part 12 and the second vehicle part 14.

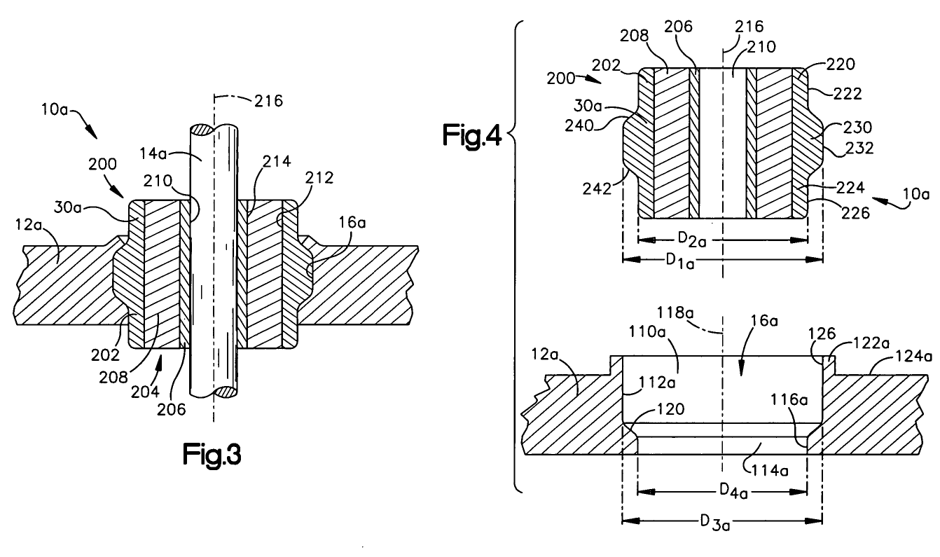

A second embodiment of the present invention is illustrated in FIGS. 3 and 4. The second embodiment of the invention is similar to the first embodiment of the invention illustrated in FIGS. 1 and 2. Accordingly, numerals similar to those of FIGS. 1 and 2 will be utilized in FIGS. 3 and 4 to identify similar components, the suffix letter “a” being associated with the numerals of FIGS. 3 and 4 to avoid confusion.

The apparatus 10a according to the second embodiment of the present invention comprises a bushing. The second embodiment of the present invention is applicable to various bushing constructions. As representative of the second embodiment of the invention, FIG. 3 illustrates a bushing 200. The bushing 200 is positioned between a first vehicle part shown partially at 12a and a second vehicle part shown partially at 14a.

The first vehicle part 12a may be a vehicle steering component such as a tie rod or a suspension component such as a leaf spring. The first vehicle portion 12 has a generally cylindrical opening 16a for receiving the bushing 200. The second vehicle part 14a may, for example, be a shaft portion of a threaded fastener.

The bushing 200 has a generally cylindrical construction and includes a canister 30a that forms a side wall or outer ring 202 of the bushing. The outer ring 202 helps define a cylindrical chamber 204 of the bushing 200. The bushing 200 also includes a cylindrical inner ring 206 and a cylindrical intermediate ring 208, both of which are disposed in the chamber 204. The inner ring 206 located centrally in the chamber 204 and defines a cylindrical bore 210 of the bushing 200. The intermediate ring 208 extends from an inner surface 212 of the outer ring 202 to an outer surface 214 of the inner ring 206. The second vehicle part 14a, outer ring 202, inner ring 206, and intermediate ring 208 are centered on and extend along a central axis 216 of the bushing 200.

According to the present invention, the outer ring 220 has a multiple diameter construction for helping to connect the outer ring to the first vehicle part 12a. Referring to FIGS. 3 and 4, the outer ring 202 includes an upper portion 220 with a cylindrical outer surface 222, a lower portion 224 with a cylindrical outer surface 226, and a central portion 230 with a cylindrical outer surface 232. The central portion 230 is disposed between the upper and lower portions 220 and 224. The upper portion 220, lower portion 224, and central portion 230 are centered on the axis 216.

Referring to FIG. 4, the central portion 230 has an outside diameter, indicated generally at D₁ₐ, that is larger than the outside diameter of the upper and lower portions 220 and 224. In the second embodiment of the invention, the upper and lower portions 220 and 224 have equal diameters, indicated generally at D₂ₐ. The central portion 230 forms upper and lower annular ridges 240 and 242, respectively. The upper annular ridge 240 extends from the outer surface 232 of the central portion 230 to the outer surface 222 of the upper portion 220. The lower annular ridge 242 extends from the outer surface 232 of the central portion 230 to the outer surface 226 of the lower portion 224.

The opening 16a in the first vehicle part 12a includes an upper portion 110a with a cylindrical inner surface 112a and a lower portion 114a with a cylindrical inner surface 116a. The upper portion 110a and lower portion 114a are centered on an axis 118a of the opening 16a.

The upper portion 110a has an inside diameter indicated generally at D₃ₐ. The lower portion 114a has an inside diameter indicated generally at D₄ₐ. The inside diameter D₃ₐ is greater than the inside diameter D₄ₐ. The lower portion 114a forms an annular ridge 120a that extends from the inner surface 116a of the lower portion 114a to the inner surface 112a of the upper portion 110a.

The first vehicle part 12a also includes an annular rim 122a that projects from an upper surface 124a of the first vehicle part. The rim 122a includes an inner surface 126a that, prior to connection of the first vehicle part 12a with the bushing 200, extends generally coextensive with and parallel to the inner surface 112a of the upper portion 110a of the opening 16a.

As illustrated in FIG. 4, prior to connecting the outer ring 220 to the first vehicle part 12a, the axis 216 of the bushing 200 is aligned with the axis 118a of the opening 16a. The opening 16a is sized so as to form an interference fit with the central portion 230 of the outer ring 220, the lower portion 224 of the canister, or both the central and lower portions of the canister. The interference could be between the lower portion 114a of the opening 16a and the lower portion 224 of the outer ring 220, i.e., the diameter D₄ₐ of the lower portion 116a is less than the diameter D₂ₐ of the lower portion 224. The interference could also be between the upper portion 110a of the opening 16a and the central portion 230 of the outer ring 220, i.e., the diameter D₃ₐ of the upper portion 110a is less than the diameter D₁ₐ of the central portion 230.

The outer ring 220 is press fitted or otherwise inserted into the opening 16a to form the interference fit between the opening and the canister. Once the outer ring 220 is fully inserted in the opening 16a such that the lower ridge 242 of the canister is seated against the ridge 120a of the first vehicle part 12a, the rim 122a is rolled over against the upper ridge 240 of the canister to help retain the canister seated in the opening. Preferably, the rim 122a is rolled over by a roll form or swage.

The outer ring 220 is thus connected to the first vehicle part 12, as illustrated in FIG. 1. The interference fit between the outer ring 220 and the opening 16, in combination with the engagement of the lower ridge 242 and the ridge 120a and the engagement of the upper ridge 240 and the rim 122a, helps provide a strong and reliable connection between the bushing 200 and the first vehicle part 12a. The second vehicle part 14a, extending through the bore 210 of the bushing 200, is connected to the first vehicle part 12a by the bushing. The second vehicle part 14a, when extending through the bushing 200, is rotational about the axis 216 of the bushing. The bushing 200 thus enables relative movement between the first vehicle part 12a and the second vehicle part 14a.

From the above description of the invention, those skilled in the art will perceive improvements, changes and modifications in the invention. Such improvements, changes and modifications within the skill of the art are intended to be covered by the appended claims.

Having described the invention, the following is claimed:

1. An apparatus for connecting a first vehicle part to a second vehicle part and enabling relative movement between the first and second vehicle parts, said apparatus comprising:
a canister fixedly connected to the first vehicle part, said canister comprising a generally cylindrical side wall that defines a generally cylindrical chamber of said canister, said side wall having an upper portion, an opposite lower portion, and a central portion positioned between said upper and lower portions, said central portion having an outside diameter greater than outside diameters of said upper and lower portions; and
a member supported by said canister, said member being fixedly connected to the second vehicle part and enabling movement of said second vehicle part relative to said canister,
said central portion and said lower portion being inserted into an opening in the first vehicle part, a portion of the first vehicle part being rolled over adjacent the intersection of said upper portion and said central portion to help fixedly connect said canister to the first vehicle part.

2. The apparatus as recited in claim 1, wherein at least one of said central portion and said lower portion have an interference fit with said opening in the first vehicle part.

3. The apparatus as recited in claim 2, wherein said canister is press fit into said opening in said first vehicle part.

4. The apparatus as recited in claim 2, wherein said central portion forms a first annular ridge extending from an outer surface of said central portion to an outer surface of said upper portion, and a second annular ridge extending from an outer surface of said central portion to an outer surface of said lower portion.

5. The apparatus as recited in claim 4, wherein said second annular ridge has an interference fit with said opening in said first vehicle part.

6. The apparatus as recited in claim 4, wherein said portion of said first vehicle part is rolled over onto said first annular ridge.

7. The apparatus as recited in claim 4, wherein said opening in said first vehicle part has an upper portion for receiving said central portion of said canister, and a lower portion for receiving said lower portion of said canister.

8. The apparatus as recited in claim 7, wherein said upper portion of said opening has a diameter slightly less than a diameter of said central portion of said canister, said upper portion of said opening creating an interference fit with said central portion of said canister.

9. The apparatus as recited in claim 7, wherein said lower portion of said opening has a diameter slightly less than a diameter of said lower portion of said canister, said lower portion of said opening creating an interference fit with said lower portion of said canister.

10. The apparatus as recited in claim 1, wherein said portion of said first vehicle part comprises an annular rim which is rolled over to help connect said canister to the first vehicle part.

11. The apparatus as recited in claim 1, wherein said canister has a central axis and a length extending along said central axis, said upper portion, said lower portion, and said central portion each having a length measured along said central axis.

12. The apparatus as recited in claim 11, wherein the length of said upper portion is generally equal to the length of said lower portion.

13. The apparatus as recited in claim 1, wherein said upper and lower portions have an equal outside diameter.

14. The apparatus as recited in claim 1, wherein the first and second vehicle parts comprise one of vehicle steering and suspension components.

15. The apparatus as recited in claim 1, wherein said member has at least a portion positioned in said chamber of said canister.

16. The apparatus as recited in claim 1, wherein said apparatus comprises a ball joint, said means for connecting comprising a ball stud having a semispherical ball end portion and a shank portion, said ball end portion being received in said chamber, said canister supporting said ball stud for movement relative to said canister, said shank portion projecting from said canister.

17. The apparatus as recited in claim 16, further comprising a bearing disposed in said chamber, said ball end portion being in mating and abutting engagement with a semispherical bearing surface of said bearing, said ball end portion being moveable over said bearing surface.

18. The apparatus as recited in claim 16, wherein said ball stud is moveable pivotally and rotationally relative to said canister.

19. The apparatus as recited in claim 1, wherein said apparatus comprises a bushing, said canister comprising an outer sleeve of said bushing, said means for supporting the second vehicle part comprising an inner sleeve of said bushing disposed in said chamber, said bushing further comprising an intermediate sleeve for supporting said inner sleeve in said chamber.

20. The apparatus as recited in claim 19, wherein said inner sleeve defines a cylindrical bore extending along a central axis of said bearing, said second vehicle part extending through said bore, said second vehicle part being rotatable about said central axis.

21. A ball joint for connecting a first vehicle part to a second vehicle part and enabling relative movement between the first and second vehicle parts, said ball joint comprising:
a canister fixedly connected to the first vehicle part, said canister comprising a generally cylindrical side wall that defines a generally cylindrical chamber of said canister, said canister having an upper portion, an opposite lower portion, and a central portion positioned between said upper and lower portions, said central portion having an outside diameter greater than outside diameters of said upper and lower portions; and
a ball stud having a semispherical ball end portion and a shank portion, said ball end portion being received in said chamber, said canister supporting said ball stud for movement relative to said canister, said shank portion projecting from said canister and having an end portion fixedly connected to the second vehicle part,
said central portion and said lower portion being inserted into the first vehicle part, a portion of the first vehicle part being rolled over adjacent the intersection of said upper portion and said central portion to help fixedly connect said canister to the first vehicle part.

22. A bushing for connecting a first vehicle part to a second vehicle part and enabling relative movement between the first and second vehicle parts, said bushing comprising:
an outer sleeve fixedly connected to the first vehicle part, said outer sleeve comprising a generally cylindrical side wall that defines a generally cylindrical chamber of said outer sleeve, said outer sleeve having an upper portion, an opposite lower portion, and a central portion positioned between said upper and lower portions, said central portion having an outside diameter greater than outside diameters of said upper and lower portions;
an inner sleeve connected to the second vehicle part, said inner sleeve enabling relative movement between said second vehicle part and said canister, said inner sleeve being supported in said chamber; and
an intermediate sleeve for supporting said inner sleeve in said chamber,
said central portion and said lower portion being inserted into the first vehicle part, a portion of the first vehicle part being rolled over adjacent the intersection of said upper portion and said central portion to help fixedly connect said canister to the first vehicle part.

23. A method for connecting a first vehicle part to a second vehicle part and enabling relative movement between the first and second vehicle parts, said method comprising the steps of:
fixedly connecting a canister to the first vehicle part, said canister comprising a generally cylindrical side wall that defines a generally cylindrical chamber of said canister, said canister having an upper portion, an opposite lower portion, and a central portion positioned between said upper and lower portions, said central portion having an outside diameter greater than outside diameters of said upper and lower portions;
providing means for connecting the second vehicle part to said canister and enabling relative movement between the second vehicle part and said canister, said means for supporting having at least a portion positioned in said chamber,
inserting said central portion and said lower portion into the first vehicle part;
rolling over a portion of the first vehicle part to help fixedly connect said canister to the first vehicle part, said portion of the first vehicle part being adjacent the intersection of said upper portion and said central portion; and
fixedly connecting the second vehicle part to said means for supporting.

24. The method as recited in claim 23, wherein said step of inserting said central portion and said lower portion into the first vehicle part comprises the step of creating an interference fit between said central portion and said first vehicle part.

25. The method as recited in claim 23, wherein said step of inserting said central portion and said lower portion into the first vehicle part comprises the step of creating an interference fit between said lower portion and said first vehicle part.

26. The method as recited in claim 23, wherein said step of rolling over a portion of the first vehicle part comprises the step of roll forming said portion of the first vehicle part.

27. The method as recited in claim 23, wherein said step of rolling over a portion of the first vehicle part comprises the step of swaging said portion of the first vehicle part.
